(19) United States
(12) Patent Application Publication
(10) Pub. No.: US 2009/0007724 A1
(43) Pub. Date: Jan. 8, 2009

(54) In Situ Created Metal Nanoparticle Strengthening of Metal Powder Articles

(76) Inventor: Jianxin Liu, Radford, VA (US)

Correspondence Address: IP & INTERNET LAW NORTH, LLC, P.O. BOX 38, ZELIENOPLE, PA, 16063, US

(21) Appl. No.: 11/666,275

(22) PCT Filed: Nov. 2, 2004
(86) PCT No.: PCT/US2004/036360

§ 371 Date: Apr. 18, 2008

(51) Int. Cl. B32B 15/00; B22F 9/00; B22F 1/00

(52) U.S. Cl. 75/230; 419/10; 75/343; 75/746

(57) ABSTRACT

The structural integrity of a metal powder body during heat treatment is enhanced by the in situ formation of metal nanoparticles. The nanoparticles bond to one another and to the metal powder particles of the powder body during heat treatment to provide strength to the powder body prior to the operation of the physical phenomena which transform the powder body into a coherent article. The precursor or precursors from which the nanoparticles are derived are preferably metal salts which are added to the powder or powder body in the form of a solution. The use of conventional binders is optional.

### TECHNICAL FIELD

The present invention relates to the field of metal powder metallurgy. More specifically, the present invention relates to enhancing the structural integrity of a metal powder body during heat treatment by the in situ formation and bonding of metallic nanoparticles to each other and to the powder particles of the metal powder body.

### BACKGROUND ART

Metal powder metallurgy has long been used to make useful articles from metal powders. Various processes are used to consolidate metal powder. Many of the processes involve forming metal powder into a shaped metal powder body at or near room temperature and then heat treating the metal powder body to consolidate it into a useable coherent article. During the heat treatment, one or more physical phenomena occur to accomplish this consolidation. For example, atomic diffusion and surface tension mechanisms may become active to consolidate the metal powder by sintering. A liquid phase may form during the heating and promote sintering and/or on cooling may form an interparticle cement. Particle cementation may also occur by infiltrating a liquid metal into the metal powder body during the heat treatment. In some cases, the consolidation is aided by, or results from, a chemical reaction that occurs as the metal powder body is heat treated. The useful article that results from the heat treatment of the metal powder body is referred to herein as the “coherent article.”

Although a coherent article typically has significant mechanical strength, the metal powder body from which it resulted is comparatively fragile. The amount of inherent structural integrity that a metal powder body has strongly depends on the process that was used to form the metal powder body. Processes, such as die pressing and cold isostatic pressing, which subject the metal powder to pressures high enough to plastically deform the metal powder particles and/or to cause diffusion bonding of the metal powder particles, produce metal powder bodies that have mechanical strengths which are a significant fraction of the mechanical strength of their corresponding coherent articles. The mechanical strength of a metal powder body is greater where the metal powder particles have irregular shapes that are amenable to mechanically interlocking with each other and which have features which are easily deformed. In contrast, processes which cause little or no deformation to the metal powder particles, such as any of the free form fabrication techniques, rely on removeable binding agents and/or physical containment or support of the metal powder body to maintain the shape of the metal powder body until it has been heat treated. The mechanical strength of metal powder bodies produced by processes that cause little or no metal powder particle mechanical deformation is particularly low where the metal powder particles are spherical or near-spherical.

The amount of mechanical strength a metal powder body has obviously determines how the metal powder body must be handled at room temperature. What is less obvious to the layman, however, but well known to one skilled in the art, is that the metal powder body's mechanical strength also determines how the metal powder body must be supported during heat treatment. Furthermore, the mechanical strength of the metal powder body often decreases dramatically due to the decomposition, evaporation, or other loss of a fugitive binder during heat treatment prior to the metal powder body reaching the processing temperature or temperature range at which the metallurgical mechanisms occur that are responsible for producing the relatively high mechanical strength of the coherent article. For example, many polymer-based conventional binders lose their effectiveness in providing strength to a metal powder body below 500° C., which is well below the temperature at which significant sintering occurs for most metal powders. Because of this, care must be taken to prevent gravity-induced distortions (which are referred to herein as “slumping”) from occurring as the metal powder body is heated above the temperature at which the binder loses its strengthening effectiveness. Measures such as the use of fixturing or of ceramic powder supports are often employed to combat slumping.

Thus, there exists a need in the art for improving the mechanical strength of metal powder bodies during heat treatment in the temperature range above which binders lose their strengthening effectiveness. This need is particularly acute for metal powder bodies which comprise spherical metal powders and which are formed by processes that cause little or no deformation to the metal powder particles.

### DISCLOSURE OF INVENTION

The present invention provides a means for strengthening metal powder bodies as they are being heat treated into coherent articles. According to the present invention, metal nanoparticles are created in situ in the metal powder body, preferably as the metal powder body is being heat treated. During subsequent or further heat treatment of the metal powder body, the metal nanoparticles become bonded to the metal powder particles of the metal powder body and to one another, thereby providing mechanical strength to the metal powder body. The metal nanoparticles are derived from a precursor that decomposes or otherwise produces the metal nanoparticles in situ.

In preferred embodiments of the present invention, the metal nanoparticles comprise a metal that is the same as or alloys with a metal contained within the metal powder particles of the powder metal body.

According to one aspect of the present invention, a method is provided wherein a liquid solution comprising at least a solvent and a dissolved metallic salt is added to a metal powder. This addition may occur before, during, or after the metal powder has been formed into a metal powder body. During heat treatment of the metal powder body, the metal salt decomposes to form metal nanoparticles on the metal powder particles and in the interstices between metal powder particles. As heating progresses, the metal nanoparticles metallurgically bond to the metal powder particles and to one another, thereby strengthening the metal powder body. Because of the high surface energy and activity of the metal nanoparticles, this metallurgical bonding occurs at lower temperatures than those at which the metallurgical mechanism or mechanisms occur that consolidate the metal powder body into a coherent article. Thus, the present invention helps to avoid slumping of the metal powder body during heat treatment.

In some preferred embodiments of the present invention, a conventional binder for providing strength to a metal powder body is also added to the metal powder. This addition may occur before, during, or after the metal powder has been formed into a metal powder body and before, during, or after the metal nanoparticle precursor is added to the metal powder body. More preferably, the conventional binder and the metal nanoparticle precursor are simultaneously added the metal powder. In embodiments utilizing a conventional binder and a metal nanoparticle precursor, it is preferred that the conventional binder is chosen so that it provides mechanical strength to the metal powder body to at least the temperature at which boding of the metal nanoparticles resulting from the metal nanoparticle precursor begin to substantially contribute to the at-temperature mechanical strength of the metal powder body. A substantial contribution to the at-temperature mechanical strength of a powder body is one which results in some measurable strengthening of the metal powder body at the temperature of interest or which prevents or lessens the amount of slumping that otherwise would occur during heat treatment.

Another benefit of the present invention is that the in situ formation of metal nanoparticles from a liquid precursor provides for controlled placement of the metal nanoparticles. For example, in embodiments of the present invention which employ three dimensional printing to form the metal powder body, the liquid precursor is applied through an ink jet print head to a bed of metal powder on a layer-by-layer basis. In such embodiments, the metal nanoparticles form only in the areas of the powder bed where the liquid precursor was applied and provide strengthening only in those areas without significantly affecting the flowability of the powder in other areas of the powder bed, e.g., powder that may be caught in passageways of the metal powder part and which needs to be removed from the metal powder body. The absence of nanoparticles in these areas of the metal powder bed enhances the reusability of that powder.

According to another aspect of the present invention, embodiments include masses of metal powder that form inter-powder particle metal nanoparticles upon heating. Other embodiments include metal powder bodies that form inter-powder particle metal nanoparticles upon heating.

According to still another aspect of the present invention, embodiments include the use of a mass of metal powder comprising metal particles and a precursor that forms inter-powder particle nanoparticles upon heating to make a coherent article. Other embodiments include the use of metal powder bodies that include a precursor that forms inter-powder particle metal nanoparticles upon heating to make coherent articles.

### MODES FOR CARRYING OUT THE INVENTION

In this section, some presently preferred embodiments of the present invention are described in detail sufficient for one skilled in the art to practice the present invention. It is to be understood, however, that the fact that a limited number of presently preferred embodiments are described herein does not in any way limit the scope of the present invention as set forth in the appended claims.

The term “nanoparticle.” is used herein to mean a microscopic particle whose particle size is measured in nanometers, i.e., particles with particle sizes of less than about one micron. Where the nanoparticles are spherical, the particle size refers to the particle diameter. Where the particle shape is non-spherical, the particle size refers to the effective diameter of the particle, that is, the diameter a spherical particle of the same mass would have. The particle size is measured by electron microscopy. Nanoparticles tend to cluster together, so care must be taken during particle size measurements to measure the primary particle size rather than the size of a cluster of nanoparticles.

In preferred embodiments of the present invention, the metal nanoparticle precursors (hereinafter referred to simply as “precursors”) are inorganic or organic metal salts. Preferred precursors decompose or otherwise result in the formation of metallic nanoparticles during the processing of the metal powder body into a coherent article. Preferably, the other decomposition or reaction products from the precursor are substantially fugitive, that is to say that they substantially exit the metal powder body prior to it becoming a coherent article. To the extent that such decomposition or reaction products are not fugitive, it is preferred that they are either inert in the resulting coherent article or improve some physical or chemical property of the coherent article.

Although the precursors employed by the present invention are preferably metal salts, they may be any chemical compound which can decompose or react to produce metal nanoparticles without substantially degrading either the physical or chemical properties of the resulting coherent body, so long as the chemical compound is able to be applied to the metal powder via a liquid vehicle, for example, by dissolution or suspension in the liquid.

The choice of a precursor preferably takes into account the composition of the metal powder with which it is to be used, the process that is to be used to form the metal powder body, and the heat treatment conditions that will be used to transform the metal powder body into a coherent article. Other factors that also should be considered in choosing a precursor are: the solvents in which it is soluble; the extent of its solubility in a solvent that is usable with the desired metal powder and in the desired powder metal body forming process; its compatibility with any conventional binder or binders with which it is to be used; its metal content level; the ease or difficulty by which it can be synthesized; the physical and chemical conditions at which it produces the desired metal nanoparticles; its environmental and health friendliness; its stability during use; its shelf life; and the full cycle cost of its use. Many of these factors are interrelated and some are competing so that a compromise as to optimization is sometimes necessary among the factors in selecting a precursor for a particular application.

Preferably, the precursor is chosen so that the resulting metal nanoparticles comprise a metal that is the same as a metal contained within the metal powder particles of the powder metal body. For example, where the metal powder particles are a nickel alloy, it is preferred that the metal nanoparticle precursor comprise nickel. This helps the nanoparticles to diffusion bond to the metal powder and to ultimately assimilate into the metal powder body as it transforms into a coherent article and avoids contamination which would detrimentally affect the properties of the coherent article. A preferred alternative is to choose the precursor to contain a metal that readily alloys with the powder metal particles.

The present invention also includes embodiments which utilize precursors which contain more than one metal species and produce metal nanoparticles comprising alloys of those metals. It also includes embodiments utilizing multiple precursors, each of which may contribute one or more metal species to the resulting metal nanoparticles. In such embodiments, the various precursors may create metal nanoparticles at the same or different temperatures. The various precursors may form metal nanoparticles of differing metals, e.g., copper nanoparticles and cobalt nanoparticles, or of alloyed nanoparticles, e.g., a copper-nickel alloy nanoparticle.

The precursor is preferably soluble in a liquid that is commonly employed with the process that is to be used for forming the metal powder body. Examples of liquids commonly used with metal powder body forming processes include water and common organic solvents such as acetone, hexane, heptane, and ethanol. Due to its environmental and health friendliness, water is the most preferred solvent in any process wherein its use is technically feasible.

The precursor also should be capable of producing a high metal ion concentration level in the solution in which it is to be applied to metal powder. Higher solution metal ion concentration levels maximize the amount of metal nanoparticles created while minimizing the amount of solution applied to the powder metal. Two factors that affect the solution metal ion concentration are: (1) the metal content level of the precursor; and (2) the solubility at the temperature of use of the precursor in the solvent being used. Maximizing either or both of these factors increases the metal ion concentration of the precursor solution.

The precursor should be chosen so that the solution it forms with the chosen solvent is stable at least up through the application of the solution to the metal powder. By stable it is meant that the metal ion remains in solution and capable of producing the desired metal nanoparticles. It is particularly important that the solution be stable even when it contains additives which may be useful or necessary for carrying out the metal powder body forming process, such as a conventional binder, a liquid vehicle or solvent for the conventional binder, surfactants, and dispersants. Such additives are preferably used when the metal powder body forming process is three dimensional printing.

It is also preferred that the precursor decompose or otherwise create metal nanoparticles in a temperature range that is significantly below the temperature range at which the metallurgical mechanisms which transform the metal powder body into a coherent article predominantly operate. Preferably, the metal nanoparticles form at temperatures at or under about 500° C.; more preferably, at temperatures at or under about 350° C.; and even more preferably at temperatures at or under about 200° C. In embodiments where a conventional binder also is used, the metal nanoparticles should not only form below the temperature or temperature range in which the conventional binder losses its effectiveness to mechanically strengthen the powder metal body, but they should as well bond together and to the metal powder particles below that temperature or temperature range.

The overall cycle cost of the precursor should be reasonable in view of the other costs of producing the coherent article after taking into account the benefits provided by use of the precursor, e.g., lower rejection costs. The overall cycle cost includes the purchase, handling, storage, and disposal costs of the precursor and of any by-products of its use. The shelf life of the precursor and of solutions containing the precursor also effect the overall cycle cost of the precursor.

In general, metal carboxylates are particularly preferred as precursors because of their high solubility in water and high metal content. In particular, cobalt acetate is preferred for use with metal powders containing cobalt, nickel acetate is preferred for use with metal powders containing nickel, and copper acetate hydrate is preferred for use with metal powders containing copper.

It is to be understood that the present invention encompasses embodiments that use more than one precursor. The individual precursors may be added into a single precursor solution or they may be used with multiple precursor solutions. The use of multiple precursors is beneficial where it is desired to form nanoparticles of different metals or where it is desired to form nanoparticles comprising metal alloys. Factors such as the identity of the temperatures of nanoparticle creation from the different precursors and the alloyability of the metals contained in the different precursors determine whether or not the use of multiple precursors results in nanoparticles of different metals or in metal alloy nanoparticles.

Some embodiments of the present invention include the use of a binder that is conventionally employed in powder metallurgy to impart strength to the metal powder body. Examples of such binders include paraffin, polyethylene glycol, vinyl polypyrrolidone, polyacrylic acid, and polyvinyl alcohol. The binder addition may occur before, during, or after the metal powder has been formed into a metal powder body and before, during, or after the metal nanoparticle precursor is added to the metal powder body. More preferably, the conventional binder and the precursor solution are combined and simultaneously added to the metal powder. For example, where the metal powder body is formed by three dimensional printing, it is preferred that the conventional binder and the precursor solution be combined into the liquid that is ink jet printed onto the successive layers of metal powder to form the metal powder body.

The present invention may be employed with any process that is used to form metal powder into a metal powder body at or about room temperature. For example, it may be used with die pressing, cold isostatic pressing, and with free form fabrication processes, e.g., three dimensional printing and selected laser sintering. It may also be used in some forming processes which are conducted at slightly elevated temperatures, e.g., metal injection molding.

In general, embodiments of the method of using the present invention include the following steps, though not necessarily in the order presented. A precursor is chosen for use with a metal powder and a metal powder body forming process. A solution containing the precursor and any desired additives, e.g., a conventional binder, is prepared. The solution is applied to the metal powder prior to, during, or after a metal powder body forming process is conducted with the metal powder. After the application of the solution and the completion of the metal powder body forming process, the metal powder body is subjected to a heat treatment under a suitable atmosphere or in vacuum. This heat treatment may be conducted in stages and with or without additional forming operations taking place between the stages. During the heat treatment, metal nanoparticles are created in the metal powder body from the precursor. As the heat treatment progresses, the metal nanoparticles bond to one another and to the metal powder particles, thus enhancing the at-temperature mechanical strength of the metal powder body during the remainder of the heat treatment to help avoid slumping. Eventually, during the heat treatment, the metallurgical mechanisms occur, e.g., sintering, which transform the metal powder body into a coherent article.

It is to be understood that not all method embodiments of the present invention require all of the foregoing steps. Some embodiments are confined to the preparation of a metal powder treated with a precursor solution. These embodiments include the steps of combining a precursor solution with a metal powder. Some other embodiments are confined to the preparation of a metal powder body treated to yield metal nanoparticles. Some of these embodiments include a step of forming a metal powder body from a metal powder treated with a precursor. Others of these embodiments include a step of treating a metal powder body with a precursor solution. Still others of these embodiments include a step of treating a metal powder body comprising metal powder that has been treated with one or more precursor solutions with one or more additional precursor solutions.

In embodiments where the precursor solution is added to the metal powder prior to the metal powder body forming process, it may be necessary after the solution has been added to heat the metal powder and/or expose it to a vacuum in order to drive off the liquid solvent of the precursor solution prior to the use of the metal powder in the forming process. In embodiments which employ metal injection molding as the metal powder body forming process, the precursor or precursor solution is combined with the conventional binder or binders prior to the pelletizing of the injection molding feed stock.

### EXAMPLE 1

Reagent grade copper acetate hydrate, Cu(CH₃CO₂)₂.H₂O, was selected as the precursor. The metal powder was spherical gas atomized grade 316 stainless steel that had been screened to a particle size range of between 45 microns (+325 U.S. mesh) and 100 microns (−140 U.S. mesh).

7.2 grams of the precursor was dissolved in 100 milliliters of distilled water to form a saturated aqueous precursor solution containing a copper concentration of about 0.36 moles/liter. 8 milliliters of the solution was mixed with 100 grams of the metal powder. The water was then removed by evaporation. The metal powder was then poured into a cylindrical mold, without tapping, and the mold removed to form a metal powder body.

The metal powder body was heated in an atmosphere of forming gas consisting of 95 volume percent nitrogen and 5 volume percent hydrogen. The heating was conducted at a rate of 5° C./minute. The temperature was held for 3 hours at 180° C. to remove any residual moisture and then at 450° C. for 4 hours, which is well below the 875° C. sintering temperature of the metal powder. The metal powder body was then cooled to room temperature and examined by scanning electron microscopy. Metal nanoparticles were observed to have formed and sintered to the metal powder particles and to one another in the interstices between the metal powder particles.

### EXAMPLE 2

All conditions were the same as for Example 1, except for the precursor and the solution concentration. Here, the precursor was nickel acetate, Ni(CH₃CO₂)₂. 17.2 grams of the precursor was added to 100 milliliters of distilled water to form a saturated aqueous solution containing a nickel concentration of about 0.96 moles/liter.

Examination of the metal powder after heating revealed that metal nanoparticles were formed and sintered to the metal powder particles and to one another in the interstices between the metal powder particles.

### EXAMPLE 3

In this test, the conventional binder PVP-K was added to a solution containing the precursor used in Example 1. PVP-K represents a series of homopolymer of vinyl pyrrolidone, which exists in a powder form and is soluble in water and a variety of organic solvents. PVP-K cures at about 150° C. by cross linking to become PVP-P, polyvinyl polypyrrolidone. It begins to degrade as a binder at about 380° C.

A saturated aqueous solution of copper acetate hydrate was prepared as in Example 1. 5 grams of PVP-K were dissolved into the precursor solution. 8 milliliters of the precursor solution was then added to 100 grams of 316 stainless steel powder and a metal powder body was prepared and the metal powder body was heat treated, all as in Example 1.

Scanning electron microscopy of the heat treated powder metal body showed that it again contained sintered metal nanoparticles. Additionally, it showed the presence of the PVP-P binder linking metal powder particles together.

### EXAMPLE 4

A saturated aqueous solution of nickel acetate was prepared as in Example 2. 5 grams of PVP-K were dissolved into the precursor solution. 8 milliliters of the solution was then added to 100 grams of 316 stainless steel powder and a metal powder body was prepared and the metal powder body was heat treated, all as in Example 2.

Scanning electron microscopy of the heat treated powder metal body showed that it again contained sintered metal nanoparticles. Additionally, it showed the presence of the PVP-P binder linking metal powder particles together.

### EXAMPLE 5

A solution containing copper acetate hydrate and PVP-K was prepared and added to 316 stainless steel powder, all as in Example 3. The metal powder was then cast into rectangular molds having dimensions of approximately 1.27 cm by 1.27 cm by 10.16 cm to make metal powder body in the form of a rectangular bar. The bar was then heated in air for 4 hours at 160° C. to cure the PVP-K. After cooling to room temperature, the rectangular bar was then supported at its ends between two ceramic supports and heated in vacuum at a rate of 5° C./minute to 450° C., held at that temperature for 1 hour and then heated at the same heating rate to 1150° C. and held for one hour at that temperature to sinter it into a coherent article, before cooling to room temperature. The coherent article showed no slumping. Note that distortion or breakage was expected if the bar had lost strength at any temperature as shown in the following comparative example.

### COMPARATIVE EXAMPLE

A rectangular bar was prepared in exactly the same manner as in Example 5, except that no copper acetate was used. Thus, the rectangular bar had only the PVP-K binder to strengthen it. After the heat treatment, the coherent article was slumped.

### EXAMPLE 6

A solution containing nickel acetate and PVP-K was prepared and added to 316 stainless steel powder, all as in Example 4. The metal powder was then cast into rectangular molds having dimensions of approximately 1.27 cm by 1.27 cm by 1.27 cm to make metal powder body in the form of a rectangular bar. The bar was then heated in air for 4 hours at 160° C. to cure the PVP-K. After cooling to room temperature, the rectangular bar was then supported at its ends between two ceramic supports and heated in vacuum at a rate of 5° C./minute to 450° C., held at the temperature for 1 hour and then heated at the same heating rate to 1150° C. and held for one hour at that temperature to sinter it into a coherent article, before cooling to room temperature. The coherent article showed no slumping.

### EXAMPLE 7

A solution containing copper acetate hydrate and PVP-K was prepared as in Example 3. Conventional surfactants for three dimensional printing were added to the precursor solution. The precursor solution was then used in a ProMetal R2 three dimensional printing machine, available from Extrude Hone Corporation, Irwin, Pa. 15642, United States, to make test bars having the dimension of 1.27 cm by 1.27 cm by 10.16 cm. The metal powder used in the three dimensional printing was a copper-nickel-tin spinodal alloy. The test bars were subjected to the heat treating steps recited in Example 5, except that a sinter temperature of 1000° C. was used instead of the 1150° C. sinter temperature of Example 5. No slumping occurred.

### EXAMPLE 8

A solution containing nickel acetate and PVP-K was prepared as in Example 4. Conventional surfactants for three dimensional printing were added to the precursor solution. The precursor solution was then employed in a ProMetal R2 three dimensional printing machine to make test bars having the dimension of 1.27 cm by 1.27 cm by 10.16 cm. The metal powder used in the three dimensional printing was Inconel 718. The test bars were subjected to the heat treating steps recited in Example 6, except that a sinter temperature of 1235° C. was used instead of the 1150° C. sinter temperature of Example 6. No slumping occurred.

While only a few embodiments of the present invention have been shown and described, it will be obvious to those skilled in the art that many changes and modifications may be made thereunto without departing from the spirit and scope of the invention as described in the following claims.

What is claimed is:

1. A method comprising the steps of:
a) creating metal nanoparticles in situ in a metal powder body; and
b) bonding directly or indirectly at least some of said metal nanoparticles to some others of said metal nanoparticles and to one or more of the metal powder particles of said metal body so as to strengthen said powder metal body.

2. The method of claim 1, further comprising the step of including in said metal powder body a precursor for creating said metal nanoparticles.

3. The method of claim 2, further comprising the step of selecting said precursor to comprise a metal salt.

4. The method of claim 2, wherein said metal salt includes a metal carboxylate.

5. The method of claim 4, wherein said metal carboxylate is at least one selected from the group consisting of cobalt acetate, nickel acetate, and copper acetate hydrate.

6. The method of claim 3, wherein said metal salt is chosen to have a metal that is the same as a metal of said metal powder particles.

7. The method of claim 3, wherein the metal salt is chosen to have a metal that alloys with said metal powder particles.

8. The method of claim 2, wherein the step of including said precursor in said metal powder body comprises adding said precursor to the metal powder of said metal powder body prior to the formation of said metal powder body.

9. The method of claim 8, further comprising the step of forming said metal powder body by a process selected from the group consisting of die pressing, cold isostatic pressing, and metal injection molding.

10. The method of claim 2, wherein the step of including said precursor in said metal powder body comprises adding said precursor to the metal powder of said metal powder body during the formation of said metal powder body.

11. The method of claim 10, further comprising the step of forming said metal powder body by a free form fabrication process.

12. The method of claim 11, wherein said free form fabrication process is three dimensional printing.

13. The method of claim 2, further comprising the step of dissolving said precursor in a solvent to create a precursor solution.

14. The method of claim 13, wherein said solvent comprises at least one selected from the group of water and an organic liquid.

15. The method of claim 13, further comprising the step of including a conventional binder in said precursor solution.

16. The method of claim 15, wherein said conventional binder is selected from the group consisting of vinyl pyrrolidone, polyvinyl alcohol, polyethylene glycol, polyacrylic acid, and paraffin.

17. The method of claim 1, wherein the step of directly or indirectly bonding includes bonding by sintering.

18. A method comprising the step of combining metal powder with a precursor for creating metal nanoparticles.

19. The method of claim 18, further comprising the step of dissolving said precursor in a solvent.

20. The method of claim 18, further comprising the step of suspending said precursor in a liquid.

21. The method of claim 18, further comprising the step of forming the combined metal powder and precursor into a metal powder body.

22. The method of claim 21, further comprising the step of applying a second precursor to said metal powder body.

23. A mass of metal powder particles comprising metal powder particles and a precursor, said precursor yielding metal nanoparticles upon heat treating said mass of metal powder.

24. The mass of metal powder particles of claim 23, wherein said precursor includes a metal salt.

25. The mass of metal powder particles of claim 24, wherein said metal salt comprises a metal that is the same as a metal of said metal powder particles.

26. The mass of metal powder particles of claim 24, wherein said metal salt comprises a metal that alloys with said metal powder particles.

27. The mass of metal powder particles of claim 24, wherein said precursor includes a metal carboxylate.

28. The mass of metal particles of claim 27, wherein said metal carboxylate is at least one selected from the group consisting of cobalt acetate, nickel acetate, and copper acetate hydrate.

29. A metal powder body comprising a precursor, said precursor yielding metal nanoparticles upon heat treating of said metal powder body.

30. The metal powder body of claim 29, wherein said precursor includes a metal salt.

31. The metal powder body of claim 30, wherein said metal salt comprises a metal that is the same as a metal of said metal powder particles.

32. The metal powder body of claim 30, wherein said metal salt comprises a metal that alloys with said metal powder particles.

33. The metal powder body of claim 30, wherein said metal salt includes a metal carboxylate.

34. The metal powder body of claim 33, wherein said metal carboxylate is at least one selected from the group consisting of cobalt acetate, nickel acetate, and copper acetate hydrate.

35. The use of a mass of metal powder particles comprising metal powder particles and a precursor, said precursor yielding metal nanoparticles upon heat treating said mass of metal powder, to make a coherent article.

36. The use described in claim 35, wherein said precursor includes a metal salt.

37. The use described in claim 36, wherein said metal salt comprises a metal that is the same as a metal of said metal powder particles.

38. The use described in claim 36, wherein said metal salt comprises a metal that alloys with said metal powder particles.

39. The use described in claim 36, wherein said precursor includes a metal carboxylate.

40. The use described in claim 39, wherein said metal carboxylate is at least one selected from the group consisting of cobalt acetate, nickel acetate, and copper acetate hydrate.
